(19) United States
(12) Patent Application Publication
(10) Pub. No.: US 2022/0062701 A1
(43) Pub. Date: Mar. 3, 2022

(54) ELECTRONIC TAG FOR GOLF SHOT DETECTION

(71) Applicant: Game Your Game, Inc., Palo Alto, CA (US)

(72) Inventors: Mickael Maxime Renault, San Francisco, CA (US); Hike Danakian, San Francisco, CA (US); Jeremy Saxton Shaw, Palo Alto, CA (US); Anton Hromadskyi, Kiev (UA)

(21) Appl. No.: 17/311,952

(22) PCT Filed: Dec. 24, 2019
(86) PCT No.: PCT/US2019/068492

§ 371 Date: Jun. 8, 2021

Related U.S. Application Data
(60) Provisional application No. 62/788,654, filed on Jan. 4, 2019.

(51) Int. Cl. A63B 24/00; A63B 60/46; A63B 69/36; G06N 3/04

(52) U.S. Cl. CPC A63B 24/0003; A63B 60/46; A63B 69/3632; A63B 2225/50; A63B 2220/40; A63B 2220/803; A63B 2220/833; G06N 3/0454

(57) ABSTRACT

Power is managed in an electronic tag attached to a golf club. A first wake event from a light sensor in the electronic tag is received. The first wake event is based on detection of light by the light sensor. A processor located inside of the electronic tag is awakened from a first low-power state to an active state in response to the first wake event. A first sensor in the electronic tag is enabled and first information is obtained by the processor from the first sensor in the electronic tag. A first orientation of the golf club is calculated based on the first information from the first sensor, and it is determined that the first orientation of the golf club is outside of a first predetermined range. In response, a second wake event based on detection of motion by the first sensor enabled. The processor is then put into the first low-power state.

### CROSS-REFERENCE TO RELATED APPLICATIONS

This application claims the benefit of U.S. Provisional Application 62/621,385 entitled ELECTRONIC TAG FOR GOLF SHOT DETECTION and filed Jan. 4, 2019 which is hereby incorporated by reference in its entirety herein for any and all purposes.

### BACKGROUND

### Technical Field

The present subject matter relates to detecting a swing of an implement during a game.

### Background Art

Many different games played by people involve swinging an implement as a part of playing the game. Examples include swinging a golf club to hit a golf ball during a round of golf, swinging a bat to hit a ball in baseball, softball, or cricket, swinging a mallet to hit a ball in croquet, and swinging a lacrosse stick to hit a ball in lacrosse. It is common for a player to take practice swings with the implement. This may take place immediately before the swing used during the actual play, or at some other time.

The technique used to swing the implement can be important in the effectiveness of hitting the ball (or other target) during the game. Coaches often help players understand what they are doing during the swinging of the implement and offer suggestions on how to improve their swing.

In some games, knowing when and where a swing takes place can also be important to the game, such as in understanding when the player starts their swing in relationship to the pitch in baseball, or knowing how many times the ball is hit in golf. Various different apparatuses are known in the art to detect the swinging of the implement, such as using a video camera to monitor the player. Such video can be used by a coach, or the player, to analyze what the player is doing and to determine things that the player could do differently to try to improve their swing. Other systems, such as that disclosed in U.S. Pat. No. # 8,617,005, provide a technique for the player to easily track the number of swings taken during a game.

### BRIEF DESCRIPTION OF THE DRAWINGS

The accompanying drawings, which are incorporated in and constitute part of the specification, illustrate various embodiments. Together with the general description, the drawings serve to explain various principles. In the drawings:

FIG. 1 shows an embodiment of a system for tracking swings during a game of golf;

FIG. 2 shows a block diagram of an embodiment of an electronic tag adapted for attachment to a golf club;

FIG. 3 shows a golfer using an embodiment of the system for tracking swings during a game of golf;

FIG. 4 shows various orientations of a golf club;

FIG. 5A, 5B, and 5C show a flowchart of an embodiment of a method for power management in an electronic tag attached to a golf club;

FIG. 6 shows a flowchart of an embodiment of a method for determining a status of a golf club;

FIG. 7 shows example sensor data in an embodiment of an electronic tag during swings of a golf club;

FIG. 8 shows a diagram of an embodiment of an artificial neural network for use in an electronic tag; and

FIG. 9 shows a flowchart of an embodiment of a method for detection of a golf shot by an electronic tag attached to a golf club.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures and components have been described at a relatively high-level, without detail, in order to avoid unnecessarily obscuring aspects of the present concepts. A number of descriptive terms and phrases are used in describing the various embodiments of this disclosure. These descriptive terms and phrases are used to convey a generally agreed upon meaning to those skilled in the art unless a different definition is given in this specification. Reference now is made in detail to the examples illustrated in the accompanying drawings and discussed below.

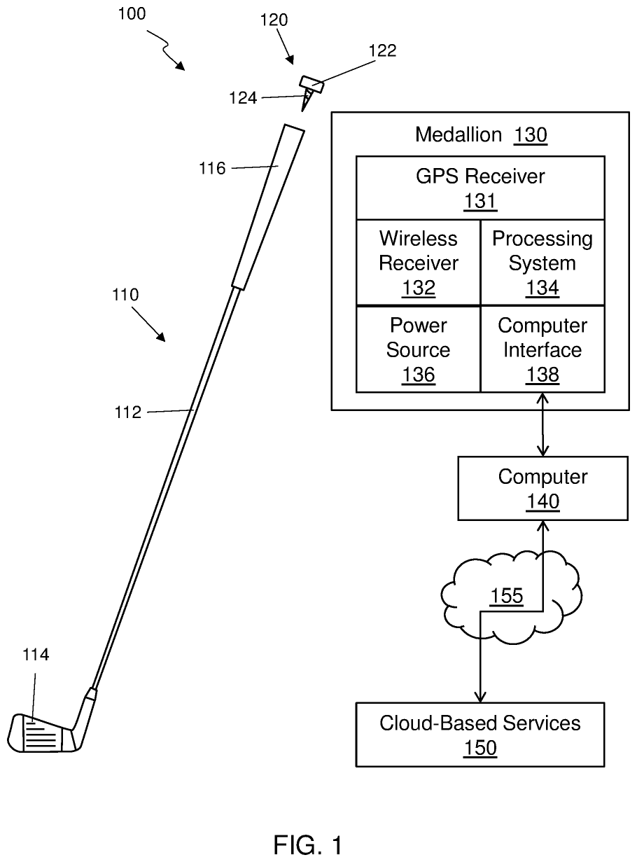

FIG. 1 shows an embodiment of a system 100 for tracking swings during a game of golf. The system includes an electronic tag 120 adapted to be attached to a golf club 110. The golf club 110 may include a shaft 112 attached to a head 114 for striking a golf ball and may also include a grip 116 to allow the golfer to hold onto the golf club 110 during a swing. The electronic tag 120 may be an electronic device with active electronics and may include a power source such as a battery. The electronic tag 120 can be attached to the golf club 110 in any suitable manner, including, but not limited, to, a clip or some other sort of fastener to attach to the shaft 112, grip 116, or head 114, embedding in the shaft 112, grip 116, or head 114, or a screw portion 124 attached to a body 122 of the electronic tag 120 to screw into a hole on the end of the grip 116.

The system 100 may also include a medallion 130, which is a second electronic device for receiving information from the electronic tag 120 and is adapted to be worn by the golfer during a round of golf. The medallion 130 may be a purpose-built device used only for the purpose of receiving the information from the electronic tag 120, or may be a general purpose device, such as a smartphone, running a application to receive the information from the electronic tag 120. The Medallion 130 includes a GPS receiver 131 to determine a position of the medallion, and therefore the golfer, during the round of golf. It also includes a wireless receiver 132 to receive the information from the electronic tag 120 and a processing system 134 to process the information received from the electronic tag 120. A computer interface 138 may also be included to allow the processing system 134 to communicate with an external computer 140, which may be a smartphone, a personal computer, or any other sort of computing device. A power source 136 is included to provide power to the active electronics, such as the GPS receiver 131, the wireless receiver 132, the processing system 134 and the computer interface 138.

Some systems 100 may include the computer 140 to act as an interface to cloud-based services 150 through the internet 155 for the medallion 130, but in some embodiments, the medallion 130 may be able to directly communicate over the internet 155 to the cloud-based services 150, eliminating the need for the computer 140 in the system 100.

During a game of golf, the electronic tag 120 may be able to determine that a golf shot has occurred and send a message indicating such to the medallion 130. The medallion 130 may store the golf shot information, along with a time tag and a location from the GPS receiver 131, in the processing system 134 for later upload to the cloud-based services 150 after the game of golf has been completed. But in other embodiments, the medallion 130 may communicate with the computer 140 to provide in-game information to the golfer, such as the number of shots that have been detected or information about how far the golfer has hit the golf ball. The cloud-based services 150 may store information from multiple games of golf for the user and provide statistical information to the user about their golf skills, such as scoring statistics, handicap information, or club hitting distance information.

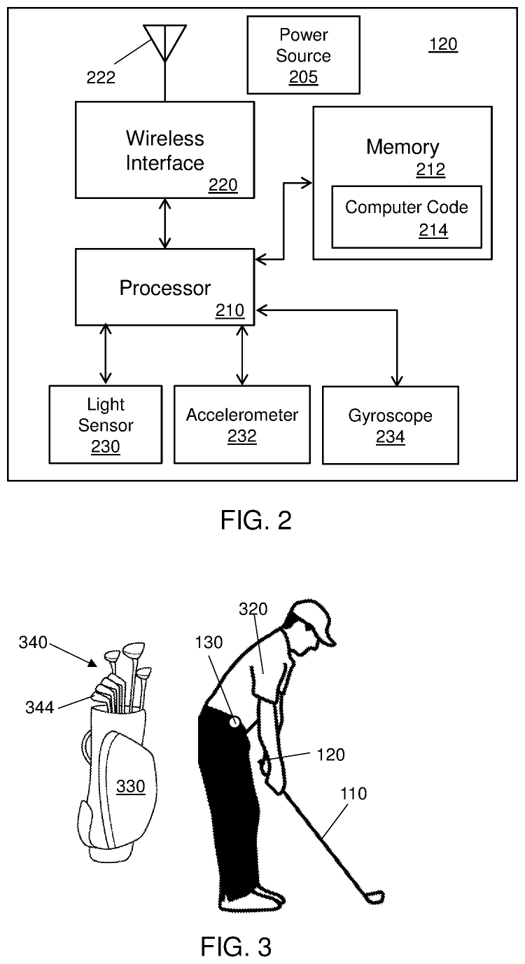

FIG. 2 shows a block diagram of an embodiment of the electronic tag 120 adapted for attachment to a golf club 110. The electronic tag 120 includes a processor 210 coupled to a memory 212 and a wireless interface 220 for communication through the antenna 222 to the medallion 130. Any type, frequency, or protocol may be supported by the wireless interface 220, depending on the embodiment, including, but not limited to, any variation of Bluetooth®, Zigbee®, Z-Wave®, or infrared communication. The processor can be any sort of electronics including a purpose-built application-specific integrated circuit (ASIC), or a general purpose central processing unit. In some embodiments, the processor 210, the wireless interface 220, and memory 212 may be included in a single integrated circuit, which may be called a system-on-a-chip (SoC) such as the QN908x family of products from NXP Semiconductors. In one example embodiment using an NXP QN9080 SoC, the wireless interface 220 supports Bluetooth 5.0 LE (low energy) and uses an ARM Cortex-M4 32-bit microprocessor core as the processor 210. The NXP QN9080 processor 210 supports a power-down mode that uses less than 1 μA of current when enabled to wake up from a general purpose input/output (GPIO) pin or 2 μA of current when enabled to wake up from a sleep timer, the real-time clock (RTC), or GPIO pin. It also supports a sleep mode where the system clock to the CPU is stopped and execution of instructions is suspended until a reset of an interrupt occurs. Internal peripherals may continue operation during the sleep state, if enabled, and may be used to generate interrupts which can wake the processor 210 back into an active state.

The memory 212 may be any type and have any amount of storage capacity, depending on the embodiment, Computer code 214 may be stored in the memory 212 to program the processor 210 to perform any method described herein, depending on the embodiment.

The electronic tag 120 also includes a light sensor 230 to allow the processor 210 to determine an amount of ambient light on the electronic tag 120. The light sensor 230 may be used to determine if the golf club 110 has been placed inside of a golf bag and is therefore is inherently not ready for a swing by the golfer. The electronic tag 120 also includes an accelerometer 232. The accelerometer 232 may include any number of accelerometers of any type. In at least one embodiment, the electronic tag 120 includes a NXP FXOS8700CQ accelerometer 232 which includes 3-axis 14-bit linear accelerometers and 3-axis 16-bit magnetometers in a single package and can take readings at up to 800 samples/second. The electronic tag 120 may also include a gyroscope 234, such as a NXP FXAS21002, which measures yaw, pitch, and roll at up to 2000°/second with 16 bit resolution and can take readings at up to 800 samples/second. Any of the accelerometers, magnetometers, or gyroscopes may be considered a sensor in the electronic tag 120.

The electronic tag includes a power source 205, such as one or more replaceable button cell batteries (e.g. a CR2032 lithium battery) to power the active electronics in the electronic tag. Other embodiments may have any other sort of power source, including, but not limited to rechargeable batteries, solar cells, a kinetic generator, or a fuel cell. Long battery life is a desirable feature as it means that the batteries in the electronic tags 120 can be replaced less often, reducing both costs and hassle for the golfer. So while the components selected for the electronic tag may have inherently low power requirements, various methods described herein may be used to reduce the power consumption by the electronic tag 120 even further.

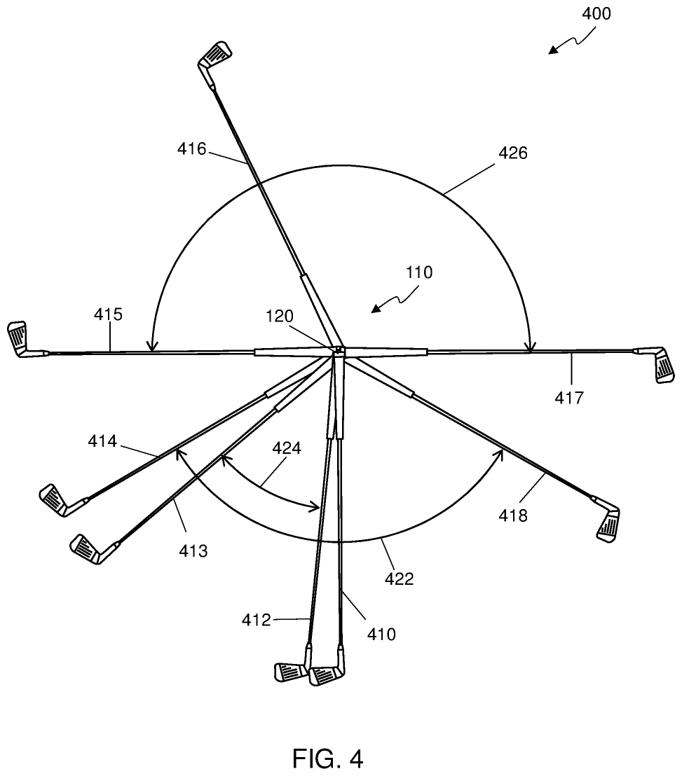

FIG. 3 shows a golfer 320 using an embodiment of the system 100 for tracking swings during a game of golf. The golfer 320 is holding the golf club 110 with electronic tag 120 attached to the end of the club 110 and is about ready to swing the golf club 110. The golfer 320 is wearing the medallion 130 to communicate with the electronic tag 120. The golfer's golf bag 330 is nearby holding the rest of the golfer's set of clubs 340, including putter 344. Note that the rest of the set of clubs 340 are all upside down in the golf bag 330 and have their grips inserted deeply into the golf bag 330 where there is little to no ambient light. Methods are disclosed to allow the electronic tags attached to the golf clubs 340 in the golf bag 330 to remain in a very low-power state for a very large percentage of the time to minimize their power usage.

As the golfer 320 took the golf club 110 out of the golf bag 330 and carried it to the position of his ball, the processor 210 in the electronic tag 120 was awakened by the light sensor 230 as it was removed from the darkness of the golf bag 330. The accelerometer 232 was then used to determine that the golf club 110 is in a position to be ready to swing, minimizing the power usage until that time. Once the golf club 110 is in a position to be ready for a swing, useful the subsystems in the electronic tag 120 are turned on and the processor is actively monitoring the output of the sensors 232, 234 to detect whether or not a golf shot has occurred.

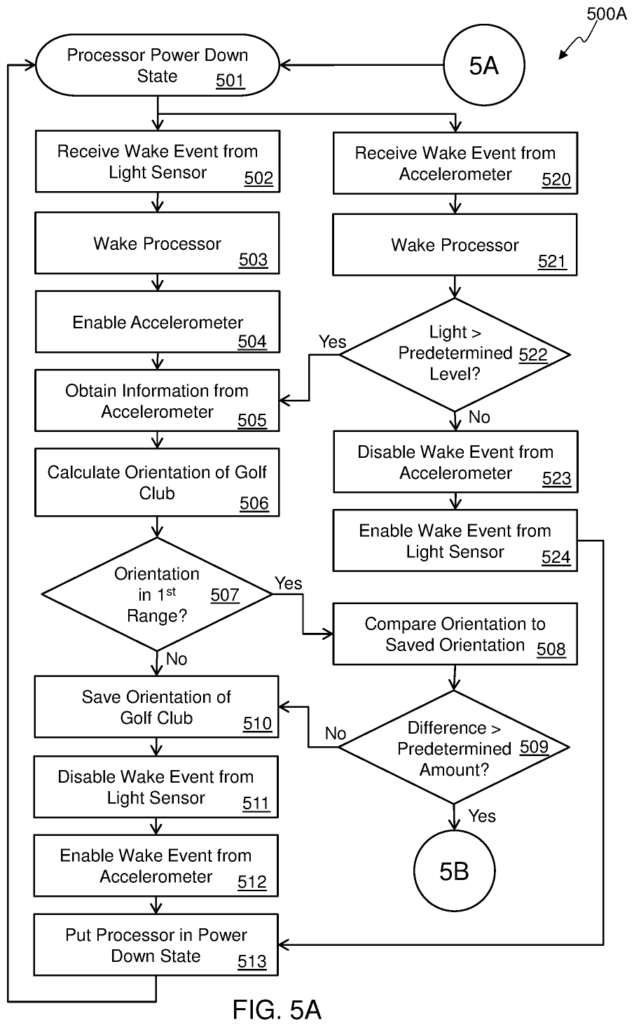

FIG. 4 shows various orientations 400 of a golf club 110. In embodiments, data from a sensor in an electronic tag 120 attached to the golf club 110 may be used to determine an orientation of the golf club 110. The orientation of the golf club 110, as the term is used herein and in the claims, refers to an angle of the golf club 110 with respect to a gravity vector (i.e. a downwards direction) using the end of the grip of the golf club 110 (which is where the electronic tag 120 is located in the embodiment shown) as the vertex for the angular measurement. In at least some embodiments, information from a 3-axis accelerometer 232 in the electronic tag 120 may be obtained by the processor 210 in the electronic tag 120 to the define a position of the gravity vector with respect to the golf club 110 in three-dimensional (3D) space.

In some embodiments, one of the axes of the accelerometer 232 may be aligned with the shaft 112 of the golf club 110, such as the ‘z-axis,’ so that the orientation of the golf club 110 at rest may be calculated as:

$$Orientation = {cos}^{- 1} \frac{z}{\sqrt{{x}^{2} + {y}^{2} + {z}^{2}}}$$

where (x, y, z) is the 3D acceleration vector and z is parallel to the shaft of the golf club.

Other methods may be used to calculate the orientation of the golf club 110, such as using information from a magnetometer in the electronic tag 120. In some embodiments, the orientation obtained from the magnetometer information may be corrected using latitude information received from the medallion, but in other embodiments, the magnetometer readings may be used without a correction for latitude. Yet other embodiments may use information from the gyroscope 234 to determine the orientation of the golf club 110. This may be accomplished through integration of the angular acceleration information received from the gyroscope 234 over time.

The golf club 110 is shown in an upright orientation 410 which would have an orientation angle of 0°. Various other positions of the golf club are shown 412-418, including horizontal positions 415, 417 and an upside down position 416. For the purposes of this disclosure, the golf club 110 is considered to be upside down (or inverted) if its orientation angle is in the range 426 between position 415 of 90° and position 417 of 270°.

In some embodiments a first range 422 of orientations between position 414 and position 418 may be defined as a range of positions that indicates that the golf club 110 is likely being readied for use, but may or may not be in an actual position to swing the golf club 110. Another way to look at the first range 422 is that if the golf club 110 is outside of the first range 422, a golf swing is not imminent and the electronic tag 120 can be put back to sleep for another period of time. For example, if the golf club 110 is not in range 422, the sensors that are not used for determining orientation can remain unpowered, such as the magnetometer and/or gyroscope 234, if only the accelerometer 232 is used to calculate orientation. In some embodiments, the first range 424 may be selected dependent upon a type of golf club. The electronic tag 120 may receive information from the medallion 130 about which type of golf club it is attached to. The type of golf club 110 may be a general type, such as putter vs non-putter or putter, iron, or wood, or the type of golf club may be specific such as the iron number (e.g. a 4 iron or a 9 iron) or wood number/type (e.g. driver or 3 wood). In some embodiments, the lie angle of the golf club 110 (i.e. the angle between the shaft 112 and the sole of the head 114) may be provided to the electronic tag 120 and be used to determine the first range 422 (or the second range 424). Any range of orientations that are not upside down (i.e. not in range 426) may be used as the first range 422, but in at least some embodiments, the first range 422 is between 60° and −60° or a range from an upright orientation 410 of the golf club 110 to a maximum angle of 60° (position 414) from the upright orientation 410 of the golf club 110.

In some embodiments, a second range 424 of orientations of the golf club 110 between position 412 and position 413 may be defined as a position where the golf club 110 is ready for use; the golf club 110 could be swung to hit a ball at any time. Once it is determined that the golf club 110 is in the second range 424, varioius subsystems within the electronic tag 120 are turned on to be ready to capture the information needed to determine whether a shot has occurred. In some embodiments, a rate of receiving information from the sensors 232, 234 may be increased once the golf club 110 is in the second range 424 of orientations.

Once a swing has been detected, the swing may evaluated to determine whether a golf shot has occurred (e.g. whether a ball has been struck). If no swing has been detected after a predetermined period of time, it may be possible that the golf club is simply resting within the first range 422 of orientations, such as being propped-up against a wall. To avoid draining power the battery simply because the golf club 110 was left in that state, it may be determined wither there is any movement of the golf club 110 during a predetermined period of time. Movement of the golf club 110 may be approximated by looking for changes in the orientation of the golf club 110. In some embodiments, it may be determined that the golf club 110 is not actually being held by a golfer if there is less than a predetermined difference in orientations between two orientation readings. Any predetermined difference may be used, but in some embodiments, the predetermined difference may be in a range of between 0.5° and 10° with at least one embodiment using a predetermined difference of about 5°.

In some embodiments, the orientation angle may be mapped to an angle between 0° and 180° with angles outside of that range, such as positions 417, 418 mirrored to the 0°-180° range by subtracting their angle from 360°. So for example, the 270° angle of position 417 would be mapped to 90°, making position 417 equivalent to position 415. But in some embodiments, the full 360° range (either 0° to 360° or −180° to 180°) may be used to allow a determination of whether the club head 114 is oriented properly for striking the ball, that is with the shaft 112 having an acute angle with the ground opposite from the club head 114, as shown in range 424. Note that the mirror of range 424 (i.e. a range between position 410 and position 418) does not put the club head 114 into a position to strike a ball when the golf club 110 is swung in a swing plane at that position.

As will be appreciated by those of ordinary skill in the art, aspects of the various embodiments may be embodied as a system, method or computer program product. Accordingly, aspects of various embodiments may take the form of an entirely hardware embodiment, an entirely software embodiment (including firmware, resident software, micro-code, or the like) or an embodiment combining software and hardware aspects that may all generally be referred to herein as a “handheld controller,” “computer,” “server,” “circuit,” “module,” “network controller,” “logic” or “system.” Furthermore, aspects of the various embodiments may take the form of a computer program product embodied in one or more computer readable medium(s) having computer readable program code stored thereon.

Any combination of one or more computer readable storage medium(s) may be utilized. A computer readable storage medium may be embodied as, for example, an electronic, magnetic, optical, electromagnetic, infrared, or semiconductor system, apparatus, or device, or other like storage devices known to those of ordinary skill in the art, or any suitable combination of computer readable storage mediums described herein. In the context of this document, a computer readable storage medium may be any tangible medium that can contain, or store a program and/or data for use by or in connection with an instruction execution system, apparatus, or device.

Computer program code for carrying out operations for aspects of various embodiments may be written in any combination of one or more programming languages, including an object oriented programming language such as Java, Smalltalk, C++, or the like, and conventional procedural programming languages, such as the “C” programming language or similar programming languages. In accordance with various implementations, the program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of various embodiments are described with reference to flowchart illustrations and/or block diagrams of methods, apparatus, systems, and computer program products according to various embodiments disclosed herein. It will be understood that various blocks of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and/or block diagrams in the figures help to illustrate the architecture, functionality, and operation of possible implementations of systems, methods and computer program products of various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

### Power Management of the Electronic Tag

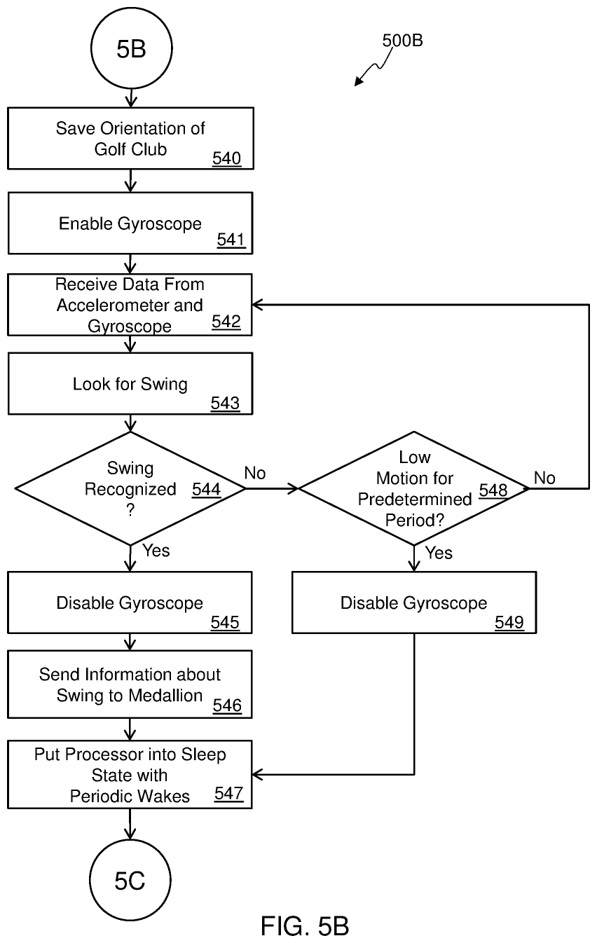

FIG. 5A, 5B, and 5C (collectively referred to as FIG. 5) show a flowchart 500A, 500B, 500C (collectively referred to as flowchart 500) of an embodiment of a method for power management in an electronic tag 120 attached to a golf club 110. Note that the flowchart is broken into three sheets but should be interpreted as a whole with connectors (labeled 5A, 5B, and 5C) showing where the flow moves between sheets.

The flowchart 500 begins with the processor 210 in a power down state 501, which may be referred to as a first low-power state. In the power down state, the processor 210 in the electronic tag 120 is in its lowest power state but it still can be awakened by events that are configured to do so before the processor 210 is put into the power down state. In at least one embodiment, a NXP QN9080 processor 210 is used which supports a power-down mode that uses less than 1 μA of current when enabled to wake up from a general purpose input/output (GPIO) pin or less than 2 μA of current when enabled to wake up from a sleep timer, the real-time clock (RTC), or GPIO pin. Thus, the processor 210 has a plurality of wakeup sources that can be used in the first low-power state 501. Some context of the processor 210 is saved in the power down state, such as the processor state, the registers and SRAM values. In addition, the logic levels of pins of the processor 210 remain static in the power down state. Note that in flowchart 500, the processor 210 is in the power down state (i.e. the first low-power state) in block 501 and in the sleep state (i.e. the second low-power state) in block 560. The processor 210 is in the active state executing instructions in all other blocks of the flowchart 500.

Before entering the power down state 501, a first wake event based on detection of light by the light sensor 230 was enabled. This may be accomplished by any mechanism, depending on the embodiment, but in at least one embodiment, it may accomplished, at least in part, by providing power to the light sensor 230 and disabling the first wake event may be accomplished, at least in part, by removing power from the light sensor 230. Certain registers in the processor 210 may also need to be configured to enable/disable the wake event from the light sensor. The light sensor 230 may be powered directly by a GPIO pin of the processor 210 in some embodiments, allowing the processor 210 to set a first output pin of the processor 210 to a high state to enable the light sensor 230 to provide the first wake event. The processor 210 may also be programmed to set the first output to a low voltage level to disable the light sensor 230 and save power during time period that the light sensor is not in use. In other embodiments, the power for the light sensor 230 may be switched using circuitry controlled by the GPIO pin of the processor 210. The output of the light sensor 230 may be coupled to another GPIO pin (or a dedicated wake pin) of the processor 210 to be used as a wake event.

Golf Club is Removed from Golf Bag

The flowchart 500 continues with receiving a first wake event 502 from a light sensor 230 in the electronic tag 120 which may be caused by the golfer removing the golf club 110 from the golf bag where the electronic tag 120 was protected from ambient light. The first wake event is based on detection of light by the light sensor. The first wake event results in waking the processor 210 located inside of the electronic tag 120 from a first low-power state (e.g. the power down state) to an active state in response to the first wake event. In the active state, the processor 210 is able to execute the computer code 214 stored in memory 212. Various functional blocks in the processor 210 may be enabled or disabled in the active state and subsystems that are not necessary for the current operations performed may be disabled to save power.

After the processor 210 is awakened, it enables a first sensor 504 in the electronic tag 210. The first sensor may be any type of sensor useable to determine an orientation of the golf club 110, but in some embodiments, the first sensor is an accelerometer 232, and may be a 3-axis accelerometer. In various embodiments, the first sensor may be integrated into the SoC with the processor 210, but in some embodiments, the first sensor may be provided by a separate integrated circuit, which may have its power controlled by a pin of the processor 210. In at least one embodiment, enabling the first sensor 504 may include setting an output pin of the processor 210 to a high state to enable the first sensor 232. The output pin of the processor 210 may be electrically connected to a power input of the first sensor 232 to directly power the first sensor 232 or the output pin may control a switch that controls power to the first sensor 232, depending on the embodiment.

Information from the first sensor 232 in the electronic tag 120 may be obtained 505 and used to calculate 506 a first orientation of the golf club 110. Thus, the first orientation of the golf club 110 is based on information from the first sensor 232. In some embodiments, the first orientation may be calculated as an average of several measurements taken by the first sensor 232. The first orientation of the golf club 110 is evaluated 507 to see if it is within a first predetermined range of orientations that may indicate that the golf club 110 is about ready to be used. Any range of non-inverted orientations may be used for the first predetermined range of orientations, but in at least one embodiment, the first predetermined range includes orientations from an upright orientation of the golf club to a maximum angle of 60° from the upright orientation of the golf club.

In some embodiments, a context for a golf swing may be received at the electronic tag 120. The context may include the type of the golf club 110, information about the golfer (e.g. various swing parameters for that golfer), or even a range of orientations specifically tailored for the golfer. In some embodiments, the first predetermined range may be selected from a set of predetermined ranges based on the context, such as a type of the golf club. In one non-limiting example, two predetermined ranges of orientations are included in an electronic tag 120, with one of the predetermined ranges used by an electronic tag attached to a putter, and the other used by electronic tags attached to a club other than a putter.

If the first orientation is outside of the first predetermined range, the orientation of the golf club 110 may be saved 510 for later use and the first wake event may be disabled 511, at least in part by removing power from the light sensor. A second wake event based on detection of motion by the first sensor is enabled 512 in response to the determination that the first orientation is outside of the first predetermined range and the processor 210 is put 513 into the first low-power state 501. There it waits for further movement of the golf club 110 to determine if a swing is eminent.

Golf Club is Returned to Bag

The flowchart 500 also includes a path to determine if the golf club 110 has been returned to the bag. A movement of the golf club 110 while the processor 210 is in the power down state 501 may cause the second wake event to be received 520 from the first sensor 232 which wakes 521 the processor 210 from the first low-power state 501 to the active state. The output of the light sensor 230 is evaluated 522 and if it is determined that light received by the light sensor 230 is below a predetermined level, indicating that the golf club 110 may have been put back into the golf bag, the second wake event may be disabled 523. In addition, the first wake event based on detection of light by the light sensor is enabled 524, and the processor put 513 into the first low-power state 501. There it waits for the golf club 110 to be removed from the bag again to cause the first wake event due to light detected by the light sensor 230.

Golf Club Left Unattended

If the golf club 110 is left unattended, but within the first predetermined range of orientations (e.g. left propped against a wall), it is possible that a slight vibration, such as that caused by a person walking by, could cause the second wake event to be received 520 to wake 521 the processor 210. Because the golf club 110 is outside of the bag, the light level will likely be determined 522 to be above the predetermined level so information will be obtained 505 from the accelerometer and a second orientation of the golf club 110 calculated 506. If the second orientation is within 507 the first predetermined range, the second orientation is compared 508 to a saved orientation of the golf club 110. In response to the second orientation differing 509 from the saved orientation by less than a predetermined difference, indicating that the golf club 110 is not moving, the second orientation of the golf club 110 may be saved 510 and the second wake event re-enabled 512. Various embodiments may use different values for the predetermined difference, but many embodiments may use a predetermined difference of between 0.5° and 10° with at least one embodiment using a predetermined difference of about 5°. While the first wake event was already disabled, some embodiments may also simply go through the process of disabling 511 the first wake event from the light sensor again. The processor 210 is then put 513 into the first low-power state 501 until the next movement of the golf club occurs.

Golf Club Ready for Use

The flowchart 500 also includes a path to determine if the golf club 110 is ready for use by the golfer. A movement of the golf club 110 while the processor 210 is in the power down state 501 may cause the second wake event to be received 520 from the first sensor 232 which wakes 521 the processor from the first low-power state 501 to the active state. The output of the light sensor 230 is evaluated 522 and if it is determined that light received by the light sensor 230 is above a predetermined level, second information is obtained 505 from the first sensor 232 in the electronic tag 120. A second orientation of the golf club is calculated 506 based on the second information and if the second orientation is within 507 the first predetermined range, the second orientation is compared 508 to a saved orientation of the golf club 110. The predetermined range can be any range of orientations, but in at embodiments, the first predetermined range may be ±90°, ±60°, or ±45° from upright. The first predetermined range is not meant to be limited to those orientations from which the golf swing may actually start, but simply to be a range that indicates the golfer may be beginning to set up for a golf shot. If the second orientation is within 507 the first predetermined range, the second orientation is compared 508 to a saved orientation of the golf club 110. In response to the second orientation differing 509 from the saved orientation by more than a predetermined difference, the second orientation of the golf club 110 may be saved 540 (in FIG. 5B). Various embodiments may use different values for the predetermined difference, but many embodiments may use a predetermined difference of between 0.5° and 10° with at least one embodiment using a predetermined difference of about 5°. Additionally, a second sensor 234, which may be a gyroscope, in the electronic tag 120 may be enabled 541 in response to the second orientation differing from the saved orientation by more than the predetermined difference. In at least some embodiments, a sample rate of the first sensor 232 may be increased during a period that the second sensor 234 is enabled, increasing the sample rate of the first sensor 232 around the time that the second sensor 234 is enabled, and decreasing the sample rate of the first sensor 232 around the time that the second sensor 234 is disabled.

Waiting for a Golf Shot

Once it has been determined that the club is ready for use, the processor 210 waits for a swing to be detected. First data from the first sensor 232 and the second sensor 234 may be received 542 over at least a first predetermined length of time. The first predetermined length of time may be any length of time, but may be 0.1 seconds, 0.5 seconds, 1.0 seconds, or 2 seconds in various embodiments. The first data is then analyzed to determine if a swing has occurred 543. If no swing is recognized 544, an amount of motion may be evaluated 548. If there is some motion of the golf club 110, but not enough to constitute a swing, more data is received 542 from the first sensor and second sensor (e.g. the accelerometer and gyroscope) to continue to look for a swing 543. If there is very little motion, the golf club 110 may be inactive, so the second sensor 549 may be disabled and the processor 210 put 547 into a second low-power state 560, such as a sleep state, with periodic wakeups enabled. This may constitute determining that the golf club was not swung during the first predetermined length of time based on at least some of the first data, and in response, disabling the second sensor and putting the processor into a second low power state. The periodic wakeups may be performed by any technique, such as an external real-time clock, a timer internal to the processor 210, or any other mechanism. The second low-power state of the processor 210 uses less power than the processor 210 uses in an active state, but more power than the processor 210 uses in the first low-power state. Note that the first sensor 232 is still enabled and collecting data while the processor 210 is in the second low-power state 560.

If a swing is recognized 544 based on at least some of the first data, the second sensor 234 is disabled 545 to save power and information about the swing of the golf club may be sent 546 through a wireless communication link to the medallion 130. In some embodiments, the medallion 130 may analyze the information about the swing to determine whether the swing resulted in hitting a golf ball and should be recognized as a golf shot, but in other embodiments, the electronic tag 120 itself may analyze the information about the swing to determine whether the swing resulted in hitting a golf ball. If the electronic tag 120 performs the analysis, it may not send information about the swing to the medallion unless a golf shot was found. After the swing is recognized and the information about the swing analyzed and/or sent 546 to the medallion 130, the processor 210 may be put into the second low-power state 560 with periodic wakeups enabled. The period of the wakeups may vary depending on the embodiment, and may be the same as the first predetermined length of time or may be shorter that the first predetermined length of time if the first sensor does not have buffers large enough to data for the first predetermined length of time. So in some embodiments, the length of the periodic wakeups may be based on the amount of data that buffers in the first sensor can store and the rate at which the first sensor is generating data.

Sleep State Loop for Electronic Tag

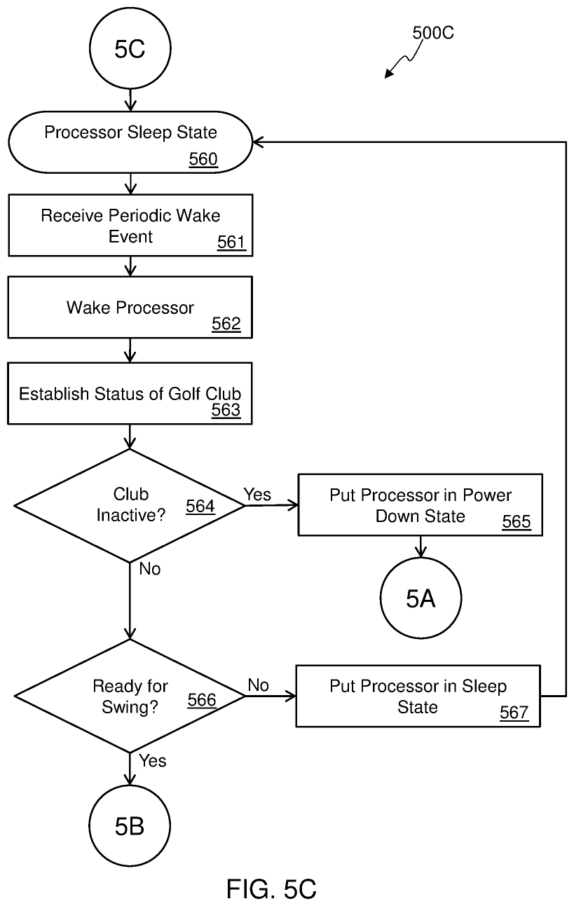

The processor 210 is in the second low-power state (i.e. the sleep state) in block 560 (FIG. 5C) of the flowchart 500, which continues with periodically receiving 561 a wake event and waking 562 the processor from the second low-power state 560 to the active state. As described above, the period used for the wake events may be based on the sample rate and buffer size of the accelerometer 232, or may be determined by the amount of data useful for the analysis of swing/shot detection and can be any length of time, depending on the embodiment. Once in the active state, the processor 210 may establish 563 a status of the golf club 110. The method of establishing a status of the golf club is shown in more detail in FIG. 6, but the status of the golf club may be “inactive,” “ready,” or “held but not ready.” The golf club 110 may be inactive if it is determined that the golf club is upside down, in the golf bag, or is not moving. The golf club 110 may also be inactive if it is determined that light received by the light sensor has been below the predetermined level for a predetermined length of time.

If the golf club has the status of inactive 564, the processor 210 is put 565 into the first low-power state 501. Note that the second wake event, which can wake the processor 210 from the first low-power state 501 is still enabled, but that the periodic wake event may be disabled at this time, either by actively disabling the periodic wake event, or by the fact that the periodic wake event is unable to wake the processor 210 from the first low-power state 501.

If the club is held but not ready 566, that is not inactive and not ready, the processor 210 may be put 567 back into the second low-power state 560 to wait for the next periodic wake event. If, however, the club is ready 566, then a swing detection process with the processor 210 in the active state is started by going back to the flowchart 500B in FIG. 5B.

Golf Club Status Determination

FIG. 6 shows a flowchart 600 of an embodiment of a method for determining a status of a golf club 601. Flowchart 600 provides more detail for block 563 of the flowchart 500 shown in FIG. 5C. To get to the flowchart 600, the electronic tag 120 may have received first data from the accelerometer 232 and second data from the gyroscope 234 at the processor 210. It may have been determined that the golf club 110 was not swung based on at least some of the first data and/or the second data, and in response, the gyroscope 234 was disabled and the processor 210 put into a sleep state. The processor 210 may have been configured to periodically wake from the sleep state to an active state where it will then perform the method described in flowchart 600 to establish a status of the golf club 110.

The flowchart 600 determines whether the light sensor has detected light 602 during a predetermined period of time. If light received by the light sensor has been below a predetermined level for a first predetermined time, which may be any amount of time but may be about 2 seconds, about 8 seconds, about 15 seconds, or about 30 seconds, depending on the embodiment, the golf club is inactive 610 and can be put into the first low-power state requiring light to be detected in order to be awakened. If light has been detected 602 by the light sensor, the accelerometer 232 may be turned on (if disabled) and information obtained 603 from the accelerometer 232 which can then used to calculate 604 an orientation of the golf club 110. The orientation may be used with previously stored orientations to determine the activity/orientations of the golf club 110 over the first predetermined period of time. If the golf club 110 has been upside down 605 for the first predetermined time, the golf club 110 is inactive 610 and can be put into the power down state. Thus, it may be determined that the golf club 110 is inactive by obtaining second data from the first sensor 232, calculating a range of orientations of the golf club 110 over a second predetermined length of time based on the second data, and determining that the range of orientations is within a range of 90° to 270° from upright. The second predetermined length of time may be the same as the first predetermined period of time or may be shorter or longer, depending on the embodiment, but in some embodiments may be in the range of 0.5 seconds to 8 seconds.

Once it is determined that the golf club 110 is not inverted, an indication of motion is calculated 606. The calculation of motion may be accomplished using any sensor data, but may be done using a change in orientation, an detection of a change in acceleration (linear and/or angular), a change in amount of light received, or by any other technique. If there is a high amount of club movement for a predetermined period of time, which may be any amount of time, but may be 0.5 seconds, 2 seconds, or 8 seconds in various embodiments, the golf club 110 is inactive 610 and can be put into the first low-power state. The amount of movement interpreted as a high amount of movement may vary, depending on the embodiment, but may correspond to movements typical for carrying the golf club 110 outside of the bag.

If the golf club 110 is not moving too much, the orientation of the golf club is checked 612 to see if it is in a second range of orientations by obtaining second data from the first sensor 232, calculating a current orientation of the golf club 110 based on the second data, and determining that the current orientation is within a second predetermined range. The second predetermined range of orientations is consistent with addressing a golf ball with the golf club 110 and may be selected from a set of predetermined ranges based on a type of the golf club 110. Thus, one range may be used for a putter while a different range is used for other clubs, different ranges for different sets of clubs (e.g. different ranges for putters, irons and woods), or a different range for each club. In other embodiments, the second predetermined range may be based on other context, such as the height, skill, or swing characteristics of the golfer or even selected based on a personal preference of the golfer. In at least one embodiment, the second predetermined range has a lower limit of between 4° and 8° from upright and an upper limit of between 40° and 60° from upright. If the current orientation is outside of the second predetermined range, the golf club 110 may have the status of held but not ready 620 (i.e. not inactive and not ready) and the processor 210 may be put back into the sleep state.

The movement of the golf club may then be checked 614 again. If the amount of movement is high, the golfer may still be setting up for the shot, indicating that the golf club 110 may have the status of held but not ready 620 (i.e. not inactive and not ready) and the processor 210 may be put back into the sleep state. If the golf club 110 has not moved for the first predetermined time, the golf club 110 may be inactive 610. But if there is some movement, but less than a predetermined amount of movement, the golf club 110 may have the status of ready 630 and swing detection may commence. The movement may be checked by obtaining acceleration data from the accelerometer 232 and calculating at least one statistical measurement of the acceleration data over a second predetermined length of time. The statistical measurement may be any type of statistical calculation, but may be an average acceleration or a range of orientations. Low motion may be determined if the at least one statistical measurement is less than a predetermined amount.

Swing detection may be done by enabling the gyroscope 234, receiving second data from the accelerometer 232 and third data from the gyroscope 234 at the processor 210, and recognizing a swing of the golf club 110 based on at least some of the first data and/or the second data. Information about the swing of the golf club 110, which may include whether or not a golf shot was detected in the swing, may be sent from the electronic tag 120 through a wireless communication link 220.

Golf Shot Detection

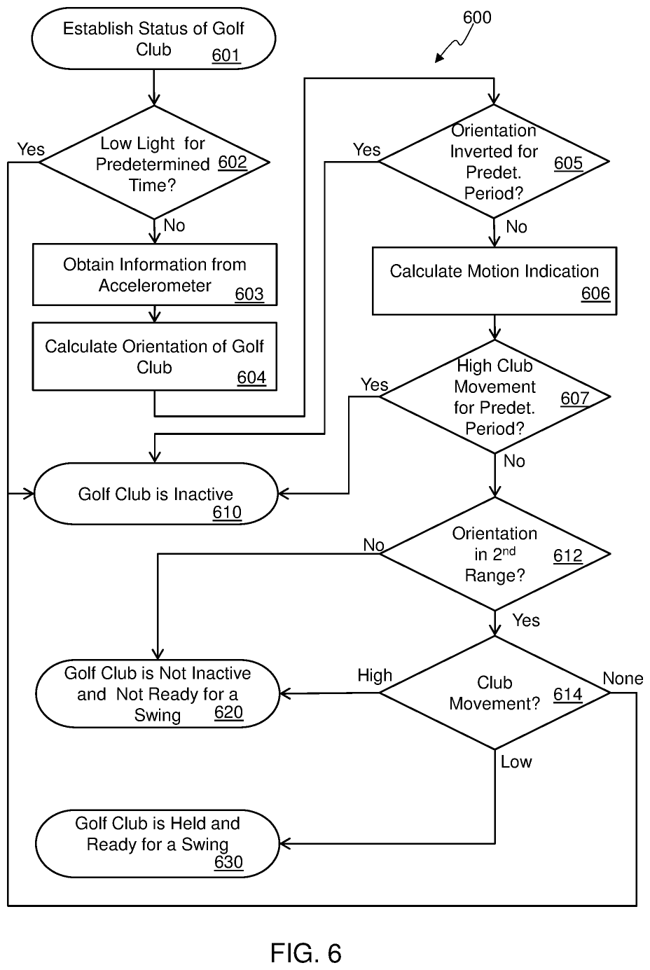

Data from the various sensors 230, 232, 234 in the electronic tag 120 collected during a swing of the golf club 110 may be used to determine whether or not the swing resulted in a golf shot. A golf shot results when the golf swing hits a golf ball. FIG. 7 shows example sensor data 700 in an embodiment of an electronic tag 120 during swings 710, 720 of a golf club 110. The x-axis represents time with the grid marks occurring 2 seconds apart. The y-axis represents amplitude of the signals and while the data collected by the various sensors has appropriate units, the particular units can be ignored and the relative amplitude within each signal used for the analysis. The sensor data 700 includes three sets of sensor data from the gyroscope 234, angular acceleration about the x-axis 702 is shown as a solid line, angular acceleration about the y-axis 704 is shown as a broken line, and angular acceleration about the z-axis 706 is shown as a dotted line. Various embodiments may include any number of streams of sensor data, such as x-axis linear acceleration, y-axis linear acceleration, and z-axis acceleration from the accelerometer 232, one or more data streams from the magnetometer, data from the light sensor, or data from any other sensor included in the electronic tag 120.

As sensor data 700 is collected from the sensors 230, 232, 234, it may be accumulated into a buffer so that it can be analyzed. In one embodiment, the buffer holds a data accumulated over a first predetermined amount of time and when the buffer is full, the data is analyzed and then discarded to allow the buffer to refill. Embodiments may have a single buffer or multiple buffers to allow so-called ping-ponging between buffers with one buffer being analyzed while the other is being filled. In another embodiment, the buffer is treated as a circular buffer holding data accumulated over the first predetermined amount of time or more. The analysis of the accumulated data may be based on the data accumulated over the first predetermined period of time, but it may be analyzed more frequently than that as shown in FIG. 7. The data from the first time period 712 may be analyzed as the buffer continues to accumulate data. Additional time periods may be analyzed as a sliding window into the data, so that the data from time period 712 has half of its data shared with the time period 714 and time period 714 shares the other half of its data with time period 716.

The sensor data 700 represents an example of data collected during a first swing 710 and a second swing 720. The first swing 710 did not result in a golf shot; it may have been a practice swing. The second swing 720 represents a golf shot which can be seen by the dip 708 in the data 702, 706.

The sensor data 700 can be analyzed using any technique, but in embodiments an artificial neural network (ANN) running in the electronic tag 120 may be used to determine whether or not a golf shot has occurred. While the ANN to perform the shot detection may be implemented in the electronic tag 120, the ANN is configured based on training data that was performed outside of the electronic tag 120. Data from thousands of golf swings that represent either golf shots or swings without a ball strike were collected and manually labelled as to whether or not the swing is a golf shot and other information such as the type of club used, the skill level of the golfer, or other contextual data related to the swing. Features were then extracted from the training data. A feature may be any type of calculation based on one or more sensor outputs over a particular time range. Examples of features include a statistical measure (e.g. minimum, maximum, average, standard deviation, and the like) of one sensor output stream (e.g. angular acceleration about the x-axis), a statistical measure of a combination of sensor output streams (e.g. the magnitude or the 3D linear acceleration vector or the orientation of the golf club), or some other calculation, such as parameters that may be calculated using an Fourier transform or other calculation. In one embodiment, a minimum, maximum, range, mean, standard deviation, root-mean-square (RMS) value, and average absolute value of delta between samples were calculated for each of the 3 linear acceleration data streams and 3 angular acceleration data streams as well as for the linear acceleration 3D magnitude and the angular acceleration 3D magnitude, for a total of 54 features. The features were extracted from the training data for a sliding window over the training data. Various windows and time steps were evaluated and a 2 second time window with 100 millisecond steps was found to be effective.

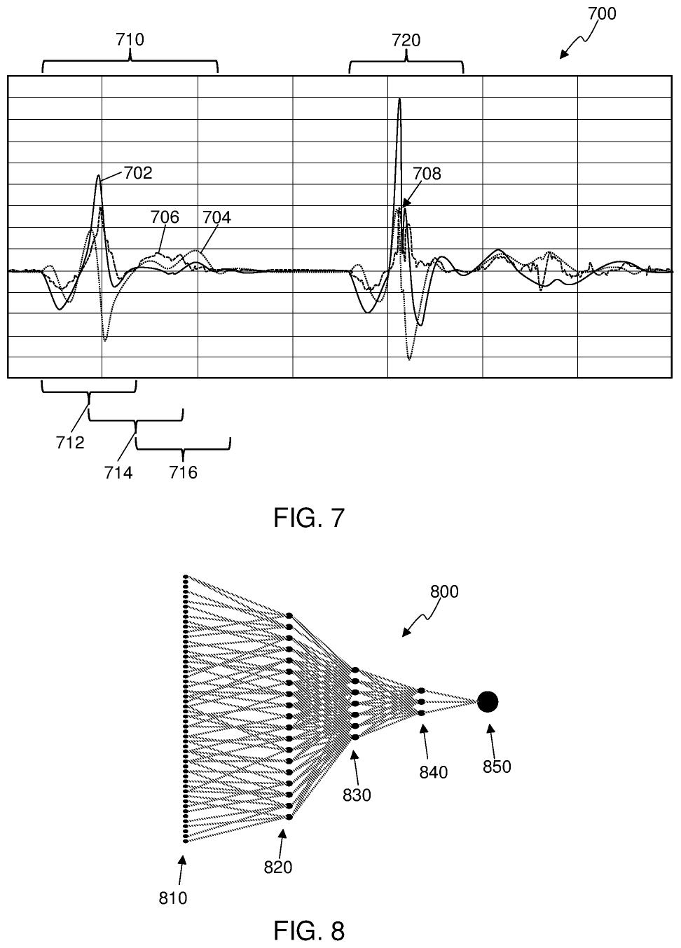

FIG. 8 shows a diagram of an embodiment of an artificial neural network (ANN) 800 for use in an electronic tag 120. The ANN can have any number of layers with the example ANN 800 having an input layer 810 to receive the inputs, an output layer 850 to generate the output which indicates whether or not a shot has occurred, and three hidden layers 820, 830, 840. Multilayer perceptron ANNs with at least two hidden layers were found to be effective. In some embodiments, multilayer perceptron ANNs with three hidden layers of 20, 5 and 5 neurons or 19, 7, and 3 neurons may be used. FIG. 8 shows a multilayer perceptron ANN 800 with 54 input neuron layer 810, a first hidden layer 820 consisting of 19 neurons, a second hidden layer 830 consisting of 7 neurons, a third hidden layer consisting of 3 neurons, and an output layer with a single neuron. The connections shown between neurons are meant to be illustrative and may not represent any actual embodiment as the output from any and all neurons of one layer may or may not be used as inputs for each neuron in the next layer. The actual connections and weights given to each connection depend upon the configuration of the specific trained ANN.

A machine learning implementation using stochastic gradient descent was used to configure the bias and weight of each perceptron (i.e. neuron—the terms are used interchangeably herein) in the target ANN using the training data. Backpropagation was used to optimize the stochastic gradient descent. In addition, features were selected during the training from the 54 features extracted to reduce the size of the input layer. Training data from putting strokes was used to train a first ANN to detect a putt, and training data from swings of other clubs (e.g. irons and woods) were used to train a second ANN to detect a golf shot. The output of the training was two ANNs, each having a particular set of features that are used as inputs and having a function for each perceptron based on weights for each perceptron of the previous level and a bias (b) from the previous level. So for example, the output perceptron of the ANN 800 would implement the function of:

ANN Output=Σ(w₃₀₀ₚ₃₀+w₃₁₀ₚ₃₁+w₃₂₀ₚ₃₂+b₃)

Where wₗₙₘ is the weight and pin is the perceptron output of perceptron n in layer l (where the input layer is layer 0), and m is the perceptron in layer l+l where the weighting is to be used. Note that the output layer has only one perceptron, that being perceptron 0. Thus, an ANN with hidden layers of 19, 7, and 3 perceptrons and using 20 of the 54 features would have 20×19+19×7+3×1 weights and 4 biases, for a total of 540 parameters to configure the ANN.

Once the training has been completed, ANNs are generated for use by the electronic tag 120. In some embodiments, code is generated that directly implements the trained ANN with the weights, biases, and the particular configuration of the perceptrons hard coded into the implementation. In other embodiments, code for the particular ANN configuration (e.g. {20, 5, 5} or {19, 7, 3} hidden layers) is generated that then accesses a table storing the parameters generated by the training. The code/data for the trained ANN(s) is then stored in the memory 212 of the electronic tag 120 as data and or computer code 214. The code/data may be stored in the electronic tag 120 at a time of manufacture, or as an update to the electronic tag 120 after it has been deployed to a golfer by providing an update through the medallion 130 over the wireless interface 220.

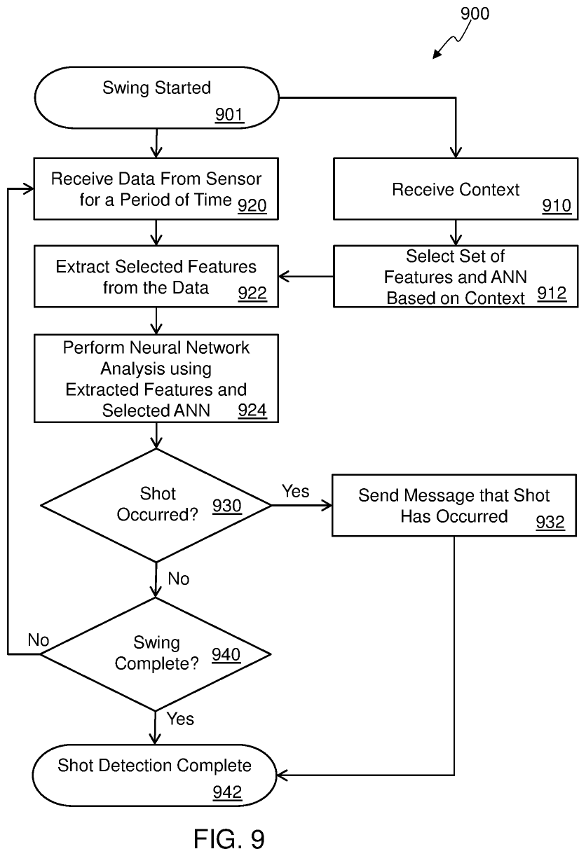

FIG. 9 shows a flowchart 900 of an embodiment of a method for detection of a golf shot by an electronic tag 120 attached to a golf club 110. A swing of the golf club is started 901 and data is received 920 from at least one sensor 232, 234 at the processor 210. The processor 210 and the at least one sensor 232, 234 are located within the electronic tag 120. In embodiments, the at least one sensor includes an accelerometer 232 and a gyroscope 234 and the data includes multiple parameters from the accelerometer 232 and multiple parameters from the gyroscope 234 corresponding to a particular time, such as time correlated x-axis linear acceleration, y-axis linear acceleration, z-axis acceleration samples from the accelerometer 232, and time correlated angular acceleration about the x-axis, angular acceleration about the y-axis, and angular acceleration about the z-axis samples from the gyroscope 234. Note that the samples from the accelerometer 232 and the samples from the gyroscope 234 may have different sample rates and may or may not be time-correlated with each other, although they are from the same period of time. Thus, the data may include a plurality of samples obtained periodically over a period of time where a sample of the plurality of samples includes a plurality of parameters provided by the at least one sensor 232, 234.

The flowchart 900 continues by extracting 922 a plurality of features from the data. The plurality of features may include a statistical measure of a single parameter of the plurality of parameters taken across the plurality of samples, such as, but not limited to, a minimum, maximum, range, mean, standard deviation, root-mean-square (RMS) value, or an average absolute value of delta between samples. The plurality of features also may include a statistical measure of a function of two or more parameters of the plurality of parameters, taken across the plurality of samples, such as, but not limited to, one of the aforementioned statistical measures of magnitudes of the 3D linear accelerations or magnitudes of the 3D angular accelerations.

In some embodiments, a context of the golf swing may be received 910. The context may be received upon configuration of the electronic tag 120 when it is attached to a particular golf club 110, or the context could be provided at the beginning of a round or hole, or the context could be provided at the time that the golf club 110 is swung. The context may include a type of the golf club 110, a skill level of a player associated with the electronic tag 120, a physical attribute of the player associated with the electronic tag 120, a distance from the electronic tag 120 to a golf hole, or any combination thereof. Thus, the method may include receiving 910, at the electronic tag 120, an indication of a type of golf club 110 attached to the electronic tag 120, in response to a registration of the electronic tag by a user, and storing the type of golf club 110 in the electronic tag 120 for use in selecting between a first set of functions for the detection of the golf shot and a second set of functions for the detection of the golf shot, wherein the first set of functions and the second set of functions are both stored in the electronic tag 120.

In some embodiments, a standard set of features are extracted 922 (i.e. calculated) for use by an ANN implemented by the computer code 214 stored in the memory 212 of the tag and used to determine whether or not a golf shot has occurred, but in other embodiments, the features extracted 922 may depend on the context of the golf swing. So in embodiments, the electronic tag 120 may select 912 between a first set of features and a second set of features based on a context of the golf swing to determine a selected set of features, wherein the plurality of features consists of the selected set of features. The selection of the features may occur from features already extracted 922 or the selection may occur before the features are extracted so that only features that will be used are extracted. In addition, the electronic tag 120 may select 912 between a first artificial neural network (ANN) and a second ANN based on a context of the golf swing to determine a selected ANN. The first ANN and the second ANN may both be stored within the electronic tag 120. In at least one embodiment, if the type of golf club used is a putter, the first set of features and/or the first ANN is selected, but if the type of golf club is not a putter, the second set of features and/or the second ANN is selected. The first ANN may include a first set of weights for use with a multilayer perceptron artificial neural network and/or may be configured to receive a first set of features as input, and the second ANN may include a second set of weights for use with the multilayer perceptron artificial neural network and/or be configured to receive a second set of features, different than the first set of features, as input. Additionally, the first ANN may include a first multilayer perceptron artificial neural network having a first configuration and the second ANN may include a second multilayer perceptron artificial neural network having a second configuration different than the first configuration.

The flowchart 900 continues with performing 924 a neural network analysis using the plurality of features as inputs to determine whether a golf shot has occurred. The neural network analysis is performed by the processor 210 in the electronic tag 120. A multilayer perceptron artificial neural network may be used to perform the neural network analysis with the multilayer perceptron artificial neural network including two or more hidden layers. In some embodiments, a perceptron of at least one hidden layer of the multilayer perceptron artificial neural network utilizes a linear activation function.

An output of the ANN may be used to determine whether or not a shot has occurred 930. If a shot has occurred, a message is sent 932 through the wireless communication interface 220 that indicates the golf shot has occurred and shot detection is complete 942. If no shot was detected, the motion of the golf club 110 may be evaluated to see if the swing is complete 940. If the golf swing is still underway, more data from the sensor is received 920 and another analysis is performed with the ANN.

One or more ANNs in the electronic tag 120 may be improved or updated during the life of the electronic tag 120 due to additional development of the ANN or improved/increased training data. In some embodiments, an ANN in the electronic tag 120 may be updated to provide improved performance. So in some embodiments, the first ANN includes a first set of instructions stored in the electronic tag and the second ANN includes a second set of instructions stored in the electronic tag. A third set of instructions may be received at the electronic tag as an update to the first ANN. The third set of instructions may be received over the wireless interface 220 from the medallion 130 or the third set of instructions may be received from another entity, such as a smartphone or personal computer using the wireless interface 220 or another wired or wireless interface. The first set of instructions in the electronic tag 120 may then be replaced with the third set of instructions without changing the second set of instructions to update the first ANN. In other embodiments, a new set of parameters for the first ANN may be provided instead of a new set of instructions to update the first ANN.

Unless otherwise indicated, all numbers expressing quantities of elements, optical characteristic properties, and so forth used in the specification and claims are to be understood as being modified in all instances by the term “about.” Accordingly, unless indicated to the contrary, the numerical parameters set forth in the preceding specification and attached claims are approximations that can vary depending upon the desired properties sought to be obtained by those skilled in the art utilizing various principles of the present disclosure. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of this disclosure are approximations, the numerical values set forth in the specific examples are reported as precisely as possible. Any numerical value, however, inherently contains certain errors necessarily resulting from the standard deviations found in their respective testing measurements. The recitation of numerical ranges by endpoints includes all numbers subsumed within that range (e.g. 1 to 5 includes 1, e, 2.0, 2.78, π, 3.3̅3̅, 4½, and 5).

Examples of various embodiments are described in the following paragraphs:

Embodiment 1. A method for power management in an electronic tag attached to a golf club, the method comprising, receiving a first wake event from a light sensor in the electronic tag, the first wake event based on detection of light by the light sensor, waking a processor located inside of the electronic tag from a first low-power state to an active state in response to the first wake event, enabling a first sensor in the electronic tag, obtaining, by the processor, first information from the first sensor in the electronic tag, calculating a first orientation of the golf club based on the first information from the first sensor, and determining that the first orientation of the golf club is outside of a first predetermined range, and in response, enabling a second wake event based on detection of motion by the first sensor and putting the processor into the first low-power state.

Embodiment 2. The method of embodiment 1, said first low-power state comprising a power-down state of the processor.

Embodiment 3. The method of embodiment 1-2, further comprising disabling the first wake event, at least in part by removing power from the light sensor.

Embodiment 4. The method of embodiment 1-3, the first sensor comprising an accelerometer.

Embodiment 5. The method of embodiment 1-4, the first predetermined range selected from a set of predetermined ranges based on a type of the golf club.

Embodiment 6. The method of embodiment 1-5, the first predetermined range comprising orientations from an upright orientation of the golf club to a maximum angle of 60° from the upright orientation of the golf club.

Embodiment 7. The method of embodiment 1-6, further comprising receiving the second wake event from the first sensor, waking the processor from the first low-power state to the active state in response to the second wake event; and determining that light received by the light sensor is below a predetermined level, and in response, enabling the first wake event based on detection of light by the light sensor and putting the processor into the first low-power state.

Embodiment 8. The method of embodiment 7, further comprising disabling the second wake event in response to the determining that light received by the light sensor is below the predetermined level, at least in part by removing power from the first sensor, and providing power to the first sensor in response to the determining that the orientation of the golf club is outside of the first predetermined range, wherein said power is provided to the first sensor while the processor is in the first low-power state.

Embodiment 9. The method of embodiment 7-8, further comprising disabling the first wake event in response to being awaken by the first wake event, at least in part by removing power from the light sensor; and providing power to the light sensor in response to the determining that light received by the light sensor is below the predetermined level, wherein said power is provided to the light sensor while the processor is in the first low-power state.

Embodiment 10. The method of embodiment 1-9, further comprising, receiving the second wake event from the first sensor, waking the processor from the first low-power state to the active state in response to the second wake event, obtaining second information from the first sensor in the electronic tag, calculating a second orientation of the golf club based on the second information, determining that the second orientation of the golf club is within the first predetermined range, comparing the second orientation of the golf club to a saved orientation of the golf club, enabling the second wake event and putting the processor into the first low-power state in response to the second orientation differing from the saved orientation by less than a predetermined difference, and enabling a second sensor in the electronic tag in response to the second orientation differing from the saved orientation by more than the predetermined difference.

Embodiment 11. The method of embodiment 10, further comprising determining that light received by the light sensor is above a predetermined level before obtaining the second information.

Embodiment 12. The method of embodiment 10-11, further comprising saving the second orientation of the golf club as the saved orientation of the golf club after said comparing.

Embodiment 13. The method of embodiment 10-12, the predetermined difference between 0.5° and 10°.

Embodiment 14. The method of embodiment 10-12, the predetermined difference about 5°.

Embodiment 15. The method of embodiment 10-14, the second sensor comprising a gyroscope.

Embodiment 16. The method of embodiment 10-15, further comprising, receiving first data from the first sensor and the second sensor, recognizing a swing of the golf club based on at least some of the first data, disabling the second sensor, sending information about the swing of the golf club through a wireless communication link, and putting the processor into a second low-power state.

Embodiment 17. The method of embodiment 16, further comprising increasing a sample rate of the first sensor during a period that the second sensor is enabled.

Embodiment 18. The method of embodiment 16-17, further comprising, periodically waking the processor from the second low-power state to the active state, establishing, by the processor after waking from the low-power state, a status of the golf club, putting the processor into the first low-power state in response to the establishing that the golf club has a status of inactive, starting a swing detection process with the processor in the active state in response to the establishing that the golf club has a status of ready, and putting the processor back into the second low-power state in response to the establishing that the golf club does not have the status of inactive and does not have the status of ready.

Embodiment 19. The method of embodiment 10-18, further comprising, receiving first data from the first sensor and the second sensor over at least a first predetermined length of time, determining that the golf club was not swung during the first predetermined length of time based on at least some of the first data, and in response, disabling the second sensor and putting the processor into a second low-power state, periodically waking the processor from the second low-power state to the active state, establishing, by the processor after waking from the low-power state, a state of the golf club, putting the processor into the first low-power state in response to the establishing that the golf club has a status of inactive, starting a swing detection process with the processor in the active state in response to the establishing that the golf club has a status of ready, and putting the processor back into the second low-power state in response to the establishing that the golf club does not have the status of inactive and does not have the status of ready.

Embodiment 20. The method of embodiment 19, the second low-power state comprising a sleep state of the processor.

Embodiment 21. The method of embodiment 19-20, the establishing that the golf club has the status of inactive comprising determining that the golf club is in the golf bag or is not moving.

Embodiment 22. The method of embodiment 19-21, the establishing that the golf club has the status of inactive comprising determining that light received by the light sensor has been below the predetermined level for a second predetermined length of time.

Embodiment 23. The method of embodiment 19-22, the establishing that the golf club has the status of inactive comprising, obtaining second data from the first sensor, calculating a range of orientations of the golf club over a second predetermined length of time ending based on the second data, determining that the range of orientations is less than a predetermined amount.

Embodiment 24. The method of embodiment 19-23, the establishing that the golf club has the status of inactive comprising, obtaining acceleration data from the first sensor, wherein the first sensor comprises an accelerometer, calculating at least one statistical measurement of the acceleration data over a second predetermined length of time, determining that the at least one statistical measurement is less than a predetermined amount.

Embodiment 25. The method of embodiment 19-24, the establishing that the golf club has the status of inactive comprising, obtaining second data from the first sensor, calculating a range of orientations of the golf club over a second predetermined length of time based on the second data, determining that the range of orientations is within a range of 90° to 270° from upright.

Embodiment 26. The method of embodiment 19-25, the establishing that the golf club has the status of ready comprising, obtaining second data from the first sensor, calculating a current orientation of the golf club based on the second data, calculating an indication of movement of the golf club based on the second data, determining that the current orientation is within a second predetermined range and the indication of movement is less than a predetermined amount.

Embodiment 27. The method of embodiment 26, the second predetermined range selected from a set of predetermined ranges based on a type of the golf club.

Embodiment 28. The method of embodiment 26-27, the second predetermined range having a lower limit of between 4° and 8° from upright and an upper limit of between 40° and 60° from upright.

Embodiment 29. The method of embodiment 26-28, the calculating the indication of movement of the golf club comprising calculating a range of orientations of the golf club over a third predetermined length of time ending at a current time based on the second data.

Embodiment 30. The method of embodiment 26-29, the calculating the indication of movement of the golf club comprising, calculating at least one statistical measurement of acceleration data over a third predetermined length of time, wherein the first sensor comprises an accelerometer and the second data comprises the acceleration data, determining that the at least one statistical measurement is less than a predetermined amount.

Embodiment 31. A method for power management in an electronic tag attached to a golf club, the method comprising, receiving first data from an accelerometer and second data from a gyroscope at a processor, the processor, accelerometer, and the gyroscope located within the electronic tag, determining that the golf club was not swung based on at least some of the first data and/or the second data, and in response, disabling the gyroscope and putting the processor into a sleep state, periodically waking the processor from the sleep state to an active state, establishing, by the processor after waking from the low-power state, a status of the golf club, putting the processor into a power down state in response to the golf club having a status of inactive, and putting the processor back into the sleep state in response to the golf club not having the status of inactive and not having a status of ready.

Embodiment 32. The method of embodiment 31, further comprising decreasing a sample rate of the accelerometer in conjunction with the disabling of the gyroscope.

Embodiment 33. The method of embodiment 31-32, the establishing that the golf club has the status of inactive comprising determining at least one of, light received by the light sensor has been below a predetermined level for a first predetermined time, the golf club has not moved for the first predetermined time; or the golf club has been upside down for the first predetermined time.

Embodiment 34. The method of embodiment 31-33, the establishing that the golf club has the status of ready comprising determining that a current orientation of the golf club is consistent with addressing a golf ball with the golf club and an amount of movement of the golf club is less than a predetermined amount.

Embodiment 35. The method of embodiment 31-34, further comprising, enabling the gyroscope in response to the golf club having the status of ready, receiving second data from an accelerometer and third data from a gyroscope at the processor, recognizing a swing of the golf club based on at least some of the first data and/or the second data, and sending information about the swing of the golf club from the electronic tag through a wireless communication link.

Embodiment 36. The method of embodiment 35, further comprising increasing a sample rate of the accelerometer in conjunction with the enabling of the gyroscope.

Embodiment 37. An article of manufacture comprising one or more non-transitory computer-readable devices storing instructions therein, which if executed by a processor, result in the performance of the method of any preceding embodiment.

Embodiment 38. An electronic tag adapted for attachment to a golf club, the electronic tag comprising, a processor having at least a first low-power state supporting a plurality of wakeup sources, a light sensor coupled to the processor; and a first sensor coupled to the processor, the processor programmed to, wake from the first low-power state into an active state in response receiving a first wake event from the light sensor based on detection of light by the light sensor, enable the first sensor, obtain first information from the first sensor, calculate a first orientation of a golf club to which the electronic tag is attached based on the first information, determine that the first orientation of the golf club is outside of a first predetermined range, and in response, enable a second wake event based on detection of motion by the first sensor and enter the first low-power state.

Embodiment 39. The electronic tag of embodiment 38, the first sensor comprising an accelerometer.

Embodiment 40. The electronic tag of embodiment 38-39, the processor further programmed to, set a first output pin of the processor to a high state to enable the light sensor to provide the first wake event, the first output pin of the processor electrically connected to a power input of the light sensor.

Embodiment 41. The electronic tag of embodiment 38-40, the processor further programmed to, set a second output pin of the processor to a high state to enable the first sensor, the second output pin of the processor electrically connected to a power input of the first sensor.

Embodiment 42. The electronic tag of embodiment 38-41, said first low-power state comprising a power-down state.

Embodiment 43. The electronic tag of embodiment 38-42, the processor further programmed to, wake from the first low-power state to the active state in response to receiving the second wake event from the first sensor, and determine that light received by the light sensor is below a predetermined level, and in response, enable the first wake event based on detection of light by the light sensor and enter the first low-power state.

Embodiment 44. The electronic tag of embodiment 43, a first output of the processor electrically coupled to a power input of the light sensor, the processor further programmed to, set the first output to a low voltage level in response to the determining that the orientation of the golf club is outside of the first predetermined range; and set the first output to a voltage level suitable to power the light sensor in response to the determining that light received by the light sensor is below the predetermined level, wherein a voltage level of the first output is maintained by the processor while in the first low-power state.

Embodiment 45. The electronic tag of embodiment 43-44, a second output of the processor electrically coupled to a power input of the first sensor, the processor further programmed to, set the second output to a low voltage level in response to the determining that light received by the light sensor is below the predetermined level, and set the second output to a voltage level suitable to power the first sensor in response to the determining that the orientation of the golf club is outside of the first predetermined range, wherein a voltage level of the second output is maintained by the processor while in the first low-power state.

Embodiment 46. The electronic tag of embodiment 38-45, the electronic tag further comprising a second sensor, the processor further programmed to, wake from the first low-power state to the active state in response to receiving the second wake event from the first sensor, obtain second information from the first sensor, calculate a second orientation of the golf club based on the second information, determine that the second orientation of the golf club is within the first predetermined range, compare the second orientation of the golf club to a saved orientation of the golf club, enable the second wake event and enter the first low-power state in response to the second orientation differing from the saved orientation by less than a predetermined difference, and enable the second sensor in response to the second orientation differing from the saved orientation by more than the predetermined difference.

Embodiment 47. The electronic tag of embodiment 46, the second sensor comprising a gyroscope.

Embodiment 48. The electronic tag of embodiment 46-47, the processor having a second low-power state, the second low-power state being a higher power state than the first low-power state, the processor further programmed to, receive first data from the first sensor and second data from the second sensor, determine that the golf club was not swung based on at least some of the first data and/or at least some of the second data, and in response, disable the second sensor and enter the second low-power state, periodically wake from the second low-power state to the active state to establish a status of the golf club, enter the first low-power state in response to the golf club having a status of inactive, start a swing detection process in response to the golf club having a status of ready, and reenter the second low-power state in response to the golf club not having the status of inactive and not having the status of ready.

Embodiment 49. The electronic tag of embodiment 46-48, the electronic tag further comprising a wireless communication interface, the processor having a second low-power state, the second low-power state being a higher power state than the first low-power state, the processor further programmed to, receive first data from the first sensor and second data from the second sensor, recognize a swing of the golf club based on at least some of the first data and/or at least some of the second data, disable the second sensor, send information about the swing of the golf club through a wireless communication link, and enter the second low-power state.

Embodiment 50. The electronic tag of embodiment 49, the processor further programmed to, periodically wake from the second low-power state to the active state to establish a status of the golf club, enter the first low-power state in response to the golf club having the status of inactive, start a swing detection process in response to the golf club having the status of ready, and reenter the second low-power state in response to the golf club not having the status of inactive and not having the status of ready.

Embodiment 51. A method for detection of a golf shot by an electronic tag attached to a golf club, the method comprising, receiving data from at least one sensor at a processor, the processor and the at least one sensor located within the electronic tag, extracting a plurality of features from the data, performing a neural network analysis, by the processor, using the plurality of features as inputs to determine whether a golf shot has occurred, and sending a message through the wireless communication interface that indicates the golf shot has occurred.

Embodiment 52. The method of embodiment 51, the at least one sensor comprising an accelerometer and a gyroscope and the data includes multiple parameters from the accelerometer and multiple parameters from the gyroscope corresponding to a particular time.

Embodiment 53. The method of embodiment 51-52, the data comprising, a plurality of samples obtained periodically over a period of time, a sample of the plurality of samples comprising a plurality of parameters provided by the at least one sensor.

Embodiment 54. The method of embodiment 53, the plurality of features comprising, a statistical measure of a single parameter of the plurality of parameters taken across the plurality of samples.

Embodiment 55. The method of embodiment 53-54, the plurality of features comprising, a statistical measure of a function of two or more parameters of the plurality of parameters, taken across the plurality of samples.

Embodiment 56. The method of embodiment 51-55, further comprising, selecting between a first set of features and a second set of features based on a context of the golf swing to determine a selected set of features, wherein the plurality of features consists of the selected set of features.

Embodiment 57. The method of embodiment 56, the context of the golf swing comprising a type of the golf club, a skill level of a player associated with the electronic tag, a physical attribute of the player associated with the electronic tag, a distance from the electronic tag to a golf hole, or any combination thereof.

Embodiment 58. The method of embodiment 56-57, the context of the golf swing comprising a type of the golf club, the method further comprising, selecting the first set of features in response to determining that the type of the golf club is a putter, and selecting the second set of features in response to determining that the type of the golf club is not the putter.

Embodiment 59. The method of embodiment 51-58, further comprising using a multilayer perceptron artificial neural network to perform the neural network analysis.

Embodiment 60. The method of embodiment 59-59, the multilayer perceptron artificial neural network comprising two or more hidden layers.

Embodiment 61. The method of embodiment 59-60, a perceptron of at least one hidden layer of the multilayer perceptron artificial neural network utilizes a linear activation function.

Embodiment 62. The method of embodiment 51-61, further comprising, selecting between a first artificial neural network (ANN) and a second ANN based on a context of the golf swing to determine a selected ANN, wherein the neural network analysis utilizes the selected ANN.

Embodiment 63. The method of embodiment 62, the context of the golf swing comprising a type of the golf club, a skill level of a player associated with the electronic tag, a physical attribute of the player associated with the electronic tag, a distance from the electronic tag to a golf hole, or any combination thereof.

Embodiment 64. The method of embodiment 62-63, the context of the golf swing comprising a type of the golf club, the method further comprising, selecting the first ANN in response to determining that the type of the golf club is a putter, and selecting the second ANN in response to determining that the type of the golf club is not the putter.

Embodiment 65. The method of embodiment 62-64, the first ANN and the second ANN both stored within the electronic tag.

Embodiment 66. The method of embodiment 62-65, the first ANN comprising a first set of weights for use with a multilayer perceptron artificial neural network and the second ANN comprising a second set of weights for use with the multilayer perceptron artificial neural network.

Embodiment 67. The method of embodiment 62-66, the first ANN comprising a first multilayer perceptron artificial neural network having a first configuration and the second ANN comprising a second multilayer perceptron artificial neural network having a second configuration different than the first configuration.

Embodiment 68. The method of embodiment 62-67, the first ANN configured to receive a first set of features as input and the second ANN configured to receive a second set of features, different than the first set of features, as input.

Embodiment 69. The method of embodiment 62-68, the first ANN comprising a first set of instructions stored in the electronic tag and the second ANN comprising a second set of instructions stored in the electronic tag, the method further comprising, receiving a third set of instructions, at the electronic tag, as an update to the first ANN, and replacing the first set of instructions in the electronic tag with the third set of instructions without changing the second set of instructions.

Embodiment 70. The method of embodiment 51-69, further comprising, receiving, at the electronic tag, an indication of a type of golf club attached to the electronic tag, in response to a registration of the electronic tag by a user, and storing the type of golf club in the electronic tag for use in selecting between a first set of functions for the detection of the golf shot and a second set of functions for the detection of the golf shot, wherein the first set of functions and the second set of functions are both stored in the electronic tag.

Embodiment 71. An article of manufacture comprising one or more non-transitory computer-readable devices storing instructions therein, which if executed by a processor, result in the performance of the method of any of embodiments 51 through 70.

Embodiment 72. An electronic tag adapted for attachment to a golf club, the electronic tag comprising, a processor, a sensor coupled to the processor, a wireless communication interface coupled to the processor, a memory device coupled to the processor and storing instructions executable by the processor that program the processor to perform the method of any of embodiments 51 through 70.

As used in this specification and the appended claims, the singular forms “a”, “an”, and “the” include plural referents unless the content clearly dictates otherwise. Furthermore, as used in this specification and the appended claims, the term “or” is generally employed in its sense including “and/or” unless the content clearly dictates otherwise. As used herein, the term “coupled” includes direct and indirect connections. Moreover, where first and second devices are coupled, intervening devices including active devices may be located there between.

The description of the various embodiments provided above is illustrative in nature and is not intended to limit this disclosure, its application, or uses. Thus, different variations beyond those described herein are intended to be within the scope of embodiments. Such variations are not to be regarded as a departure from the intended scope of this disclosure. As such, the breadth and scope of the present disclosure should not be limited by the above-described exemplary embodiments, but should be defined only in accordance with the following claims and equivalents thereof.

1-50. (canceled)

51. A method for detection of a golf shot by an electronic tag attached to a golf club, the method comprising:
receiving data from at least one sensor at a processor, the processor and the at least one sensor located within the electronic tag;
extracting a plurality of features from the data;
performing a neural network analysis, by the processor, using the plurality of features as inputs to determine whether a golf shot has occurred; and
sending a message through the wireless communication interface that indicates the golf shot has occurred.

52. The method of claim 51, the at least one sensor comprising an accelerometer and a gyroscope and the data includes multiple parameters from the accelerometer and multiple parameters from the gyroscope corresponding to a particular time.

53. The method of claim 51, the data comprising;
a plurality of samples obtained periodically over a period of time;
a sample of the plurality of samples comprising a plurality of parameters provided by the at least one sensor.

54. The method of claim 51, the plurality of features comprising;
a statistical measure of a single parameter of the plurality of parameters taken across the plurality of samples.

55. The method of claim 51, the plurality of features comprising;
a statistical measure of a function of two or more parameters of the plurality of parameters, taken across the plurality of samples.

56-58. (canceled)

59. The method of claim 51, further comprising using a multilayer perceptron artificial neural network to perform the neural network analysis.

60-61. (canceled)

62. The method of claim 51, further comprising:
selecting between a first artificial neural network (ANN) and a second ANN based on a context of the golf swing to determine a selected ANN, wherein the neural network analysis utilizes the selected ANN.

63. The method of claim 62, the context of the golf swing comprising a type of the golf club, a skill level of a player associated with the electronic tag, a physical attribute of the player associated with the electronic tag, a distance from the electronic tag to a golf hole, or any combination thereof.

64. The method of claim 62, the context of the golf swing comprising a type of the golf club, the method further comprising:
selecting the first ANN in response to determining that the type of the golf club is a putter; and
selecting the second ANN in response to determining that the type of the golf club is not the putter.

65. The method of claim 62, the first ANN and the second ANN both stored within the electronic tag.

66. The method of claim 62, the first ANN comprising a first set of weights for use with a multilayer perceptron artificial neural network and the second ANN comprising a second set of weights for use with the multilayer perceptron artificial neural network.

67-70. (canceled)

71. An article of manufacture comprising one or more non-transitory computer-readable devices storing instructions therein, which if executed by a processor, result in the performance of a method comprising:
receiving data from at least one sensor at a processor, the processor and the at least one sensor located within the electronic tag;
extracting a plurality of features from the data;
performing a neural network analysis, by the processor, using the plurality of features as inputs to determine whether a golf shot has occurred; and
sending a message through the wireless communication interface that indicates the golf shot has occurred.

72. An electronic tag adapted for attachment to a golf club, the electronic tag comprising:
a processor;
a sensor coupled to the processor;
a wireless communication interface coupled to the processor;
a memory device coupled to the processor and storing instructions executable by the processor that program the processor to perform a method comprising:
receiving data from at least one sensor at a processor, the processor and the at least one sensor located within the electronic tag;
extracting a plurality of features from the data;
performing a neural network analysis, by the processor, using the plurality of features as inputs to determine whether a golf shot has occurred; and
sending a message through the wireless communication interface that indicates the golf shot has occurred.

73. The electronic tag of claim 72, the method further comprising:
selecting between a first artificial neural network (ANN) and a second ANN based on a context of the golf swing to determine a selected ANN, wherein the neural network analysis utilizes the selected ANN;
wherein the context of the golf swing comprises a type of the golf club, a skill level of a player associated with the electronic tag, a physical attribute of the player associated with the electronic tag, a distance from the electronic tag to a golf hole, or any combination thereof.

74. The electronic tag of claim 73, the context of the golf swing comprising a type of the golf club, the method further comprising:
selecting the first ANN in response to determining that the type of the golf club is a putter; and
selecting the second ANN in response to determining that the type of the golf club is not the putter.

75. The electronic tag of claim 73, further comprising the first ANN and the second ANN.

76. The article of manufacture of claim 71, the data comprising;
a plurality of samples obtained periodically over a period of time;
a sample of the plurality of samples comprising a plurality of parameters provided by the at least one sensor.

77. The article of manufacture of claim 71, the plurality of features comprising;
a statistical measure of a single parameter of the plurality of parameters taken across the plurality of samples.

78. The article of manufacture of claim 71, the plurality of features comprising;
a statistical measure of a function of two or more parameters of the plurality of parameters, taken across the plurality of samples.

79. The article of manufacture of claim 71, further storing a plurality of weights for a first artificial neural network (ANN) and a second ANN, the method further comprising:
selecting between the first ANN and the second ANN based on a context of the golf swing to determine a selected ANN, wherein the neural network analysis utilizes the selected ANN;
wherein the context of the golf swing comprises a type of the golf club, a skill level of a player associated with the electronic tag, a physical attribute of the player associated with the electronic tag, a distance from the electronic tag to a golf hole, or any combination thereof.
